(19) United States
(12) Patent Application Publication
(10) Pub. No.: US 2023/0307182 A1
(43) Pub. Date: Sep. 28, 2023

(54) HIGH-VOLTAGE ANTIFERROELECTRIC AND MANUFACTURING METHOD THEREOF

(71) Applicants: HYUNDAI MOTOR COMPANY, Seoul (KR); KIA CORPORATION, Seoul (KR); AMOTECH CO., LTD., Incheon (KR); Korea Institute of Ceramic Engineering and Technology, Jinju-si (KR)

(72) Inventors: Hyung Suk Kim, Gwangmyeong-si (KR); Sung Jin Hong, Seoul (KR); Hyun Jin Jo, Seoul (KR); Jae Woo Choi, Seoul (KR); Hyo Soon Shin, Jinju-si (KR); Dong Hun Yeo, Seoul (KR); Jeoung Sik Choi, Changwon-si (KR)

(73) Assignees: HYUNDAI MOTOR COMPANY, Seoul (KR); KIA CORPORATION, Seoul (KR); AMOTECH CO., LTD., Incheon (KR); Korea Institute of Ceramic Engineering and Technology, Jinju-si (KR)

(21) Appl. No.: 18/103,883

(22) Filed: Jan. 31, 2023

(30) Foreign Application Priority Data
Mar. 28, 2022 (KR) 10-2022-0038033

(51) Int. Cl. H01G 4/12; H01G 13/00

(52) U.S. Cl. CPC H01G 4/1236; H01G 13/00

(57) ABSTRACT

A high-voltage antiferroelectric and a method for manufacturing the same are provided. The antiferroelectric has a composition of PbₓLa₁₋ₓ([Zr_{1-Y}Sn_{Y}]_{Z}Ti_{1-Z}). The antiferroelectric is sintered at a low temperature, and has a high density and a high breakdown voltage.

### CROSS REFERENCE TO RELATED APPLICATION

The present application claims priority to Korean Patent Application No. 10-2022-0038033, filed Mar. 28, 2022, the entire contents of which is incorporated herein for all purposes by this reference.

### BACKGROUND

### 1. Technical Field

The present disclosure relates to a high-voltage antiferroelectric and a method for manufacturing the same. More particularly, the present disclosure relates to an antiferroelectric having a composition of PbₓLa₁₋ₓ([Zr_{1-Y}Sn_{Y}]_{Z}Ti_{1-Z}), being sintered at a low temperature, and having a high breakdown voltage.

### 2. Description of the Related Art

The statements in this section merely provide background information related to the present disclosure and may not constitute prior art.

A direct current (DC) link capacitor is included in an inverter of an electric vehicle drive motor. A polypropylene film or the like may be used as an insulator in a capacitor applied to the inverter. In this case, because a polymer material is used as the insulator, there is a problem that operation at a high temperature is impossible.

In order to solve the above problems, conventionally, a method of covering the film-type capacitor with a heat dissipation molding material has been used, but this has a new problem of increasing the size and weight of the entire capacitor. Therefore, in order to solve the above problems, barium titanate (BaTiO₃), which is a material having excellent dielectric constant, capacity, and excellent temperature characteristics, is used, but barium titanate has a disadvantage in that the dielectric constant is reduced at a high-voltage.

Conventionally, in order to solve the above problems, an attempt is being made to replace a BaTiO₃ material, in which a dielectric constant decreases as a voltage increases, with an antiferroelectric (AFE) material, in which a dielectric constant and a capacitor capacity increase as a high-voltage is used.

Currently, as the antiferroelectric material, an antiferroelectric composition development based on a (Pb(La)(Zr, Ti)O₃) material composed of lead, lanthanum, zirconium, and titanium is actively being developed.

### SUMMARY

The objective of the present disclosure is to provide an antiferroelectric material that can be sintered at a low temperature and has a high density and a high breakdown voltage.

The objectives of the present disclosure are not limited to the objective mentioned above. The above and other objectives of the present disclosure become clearer from the following description and are realized by means and combinations thereof described in the claims.

The high-voltage antiferroelectric, according to the present disclosure, may represented by PbₓLa₁₋ₓ([Zr_{1-Y}Sn_{Y}]_{Z}Ti_{1-Z}) (wherein X is in a range of 0.86 to 0.90, Y is in a range of 0.52 to 0.56, and Z is in a range of 0.84 to 0.88.

The density of the high-voltage antiferroelectric may be in the range of 7.5 g/cm³ to 8.0 g/cm³.

The permittivity (ε) of the high-voltage antiferroelectric may be in the range of 900 to 1000.

A breakdown voltage of the high-voltage antiferroelectric may be in the range of 9.5 kV/mm to 10.5 kV/mm.

The sintering temperature of the high-voltage antiferroelectric may be in the range of 900° C. to 1100° C.

A method of manufacturing a high-voltage antiferroelectric, according to the present disclosure, includes preparing a precursor mixture by mixing each element of a precursor of a dielectric; calcining the precursor mixture; manufacturing a molded product by pressurizing a calcined resultant product; and sintering the molded product to obtain a sintered body.

The precursor of the dielectric may include 50% to 60% by weight of lead oxide (PbO), 15% to 30% by weight of zirconium oxide (ZrO₂), 1% to 5% by weight of titanium oxide (TiO₂), 8% to 14% by weight of lanthanum oxide (La₂O₅), and 1% to 16% by weight of tin oxide (SnO₂).

The molded product may be sintered with a sintering agent that includes 1% to 4% by weight of zinc oxide (ZnO) and 1% to 10% by weight of lead oxide (PbO).

And the capacitor, according to the present disclosure, may include the high-voltage antiferroelectric as disclosed herein and an electrode disposed on a surface of the high-voltage antiferroelectric, wherein the electrode includes copper (Cu).

According to the present disclosure, it is possible to provide an antiferroelectric that can be sintered at a low temperature.

According to the present disclosure, it is possible to provide an antiferroelectric having a high density.

According to the present disclosure, it is possible to provide an antiferroelectric having a high breakdown voltage.

The effects of the present disclosure are not limited to the effects mentioned above. It should be understood that the effects of the present disclosure include all effects that can be inferred from the following description.

### BRIEF DESCRIPTION OF THE DRAWINGS

In order that the disclosure may be well understood, there will now be described various forms thereof, given by way of example, reference being made to the accompanying drawings, in which:

FIG. 1 shows a flowchart showing an example of a method for manufacturing a high-voltage antiferroelectric according to the present disclosure;

FIG. 2A shows a density according to the sintering temperature according to the Y value in the composition of Pb_{0.88}La_{0.12}([Zr_{1-Y}Sn_{Y}]_{0.86}Ti_{0.14});

FIG. 2B shows a dielectric constant according to Y value in the composition of Pb_{0.88}La_{0.12}([Zr_{1-Y}Sn_{Y}]_{0.86}Ti_{0.14});

FIG. 2C shows a breakdown voltage according to the Y value in the composition of Pb_{0.88}La_{0.12}([Zr_{1-Y}Sn_{Y}]_{0.86}Ti_{0.14});

FIG. 2D shows the X-ray diffraction (XRD) according to the Y value in the composition of Pb_{0.88}La_{0.12}([Zr_{1-Y}Sn_{Y}]_{0.86}Ti_{0.14});

FIG. 3 shows a density according to the sintering temperature when NiO and ZnO are added to the composition of Pb_{0.88}La_{0.12}([Zr_{1-Y}Sn_{Y}]_{0.86}Ti_{0.14});

FIG. 4A shows a density and shrinkage according to the PbO content at a sintering temperature of 950° C.;

FIG. 4B shows a density and shrinkage according to the PbO content at a sintering temperature of 1000° C.;

FIG. 5A shows a density and shrinkage according to the Sn molar ratio (Y value) in the composition of Pb_{0.88}La_{0.12}([Zr_{1-Y}Sn_{Y}]_{0.86}Ti_{0.14});

FIG. 5B shows a dielectric constant and breakdown voltage according to the Sn molar ratio (Y value) in the composition of Pb_{0.88}La_{0.12}([Zr_{1-Y}Sn_{Y}]_{0.86}Ti_{0.14});

FIG. 6A shows a dielectric constant and breakdown voltage when the Z value is less than 0.84 in the composition of Pb_{0.88}La_{0.12}([Zr_{0.46}Sn_{0.54}]_{Z}Ti_{1-Z}); and

FIG. 6B shows a dielectric constant and breakdown voltage when the Z value is greater than 0.88 in the composition of Pb_{0.88}La_{0.12}([Zr_{0.46}Sn_{0.54}]_{Z}Ti_{1-Z}).

### DETAILED DESCRIPTION

The above objectives, other objectives, features, and advantages of the present disclosure are understood through the following embodiments in conjunction with the accompanying drawings. However, the present disclosure is not limited to the embodiments described herein and may be embodied in other forms. Rather, the embodiments introduced herein are provided so that the disclosed content may be thorough and complete, and the spirit of the present disclosure may be sufficiently conveyed to those skilled in the art.

Like reference numerals have been used for like elements in describing each figure. In the accompanying drawings, the dimensions of the structures are enlarged than the actual size for clarity of the present disclosure. Terms such as first, second, etc., may be used to describe various elements, but the elements should not be limited by the terms. The above terms are used only for the purpose of distinguishing one component from another. For example, without departing from the scope of the present disclosure, a first component may be referred to as a second component, and similarly, a second component may also be referred to as a first component. The singular expression includes the plural expression unless the context clearly dictates otherwise.

In this specification, the terms “include” or “have” should be understood to designate that one or more of the described features, numbers, acts, operations, components, or a combination thereof exist, and the possibility of addition of one or more other features or numbers, operations, components, or combinations thereof should not be excluded in advance. Also, when a part of a layer, film, region, plate, etc., is said to be “on” another part, this includes not only the case where it is “on” another part but also the case where there is another part in between. Conversely, when a part of a layer, film, region, plate, etc., is said to be “under” another part, this includes not only cases where it is “directly under” another part but also a case where another part is in the middle.

Unless otherwise specified, all numbers, values, and/or expressions expressing quantities of ingredients, reaction conditions, polymer compositions, and formulations used herein contain all numbers, values and/or expressions in which such numbers occur in obtaining such values, among others. Because they are approximations reflecting various uncertainties in the measurement, it should be understood as being modified by the term “about” in all cases. In addition, when a numerical range is disclosed in this disclosure, this range is continuous and includes all values from the minimum to the maximum value containing the maximum value of this range unless otherwise indicated. Furthermore, when such a range refers to an integer, all integers, including the minimum value to the maximum value containing the maximum value, are included unless otherwise indicated.

High-Voltage Antiferroelectric

The high-voltage antiferroelectric, according to the present disclosure, may have the composition of PbₓLa₁₋ₓ([Zr_{1-Y}Sn_{Y}]_{Z}Ti_{1-Z}) (wherein X, Y, and Z are numbers between 0 and 1).

The present disclosure is characterized in that an antiferroelectric material that can be used at high-voltage is applied.

The present disclosure may improve the storage energy density by substituting Sn for Zr in Pb(La)(Zr, Ti)O₃ (hereinafter PLZT) composed of lead, lanthanum, zirconium, and titanium as an antiferroelectric material.

X may be in a range of 0.86 to 0.90.

Y may be in a range of 0.52 to 0.56.

In this case, when Y is less than 0.52 or more than 0.56, there may be a problem in that both the density and the degree of shrinkage decrease.

Z may be in a range of 0.84 to 0.88.

In this case, when Z is less than 0.84, the dielectric constant (permittivity) increases, but a problem that the breakdown voltage decreases may occur, and when the Z exceeds 0.88, the dielectric constant may be reduced.

The ratio of X and Z is in a range of 1:1.1 to 1:1.3.

In this case, when X and Z are out of the above ratio, there may be a problem in that the breakdown voltage decreases.

The density of the high-voltage antiferroelectric may be in a range of 7.5 g/cm³ to 8.0 g/cm³.

The permittivity (ε) of the high-voltage antiferroelectric may be in a range of 900 to 1000.

The breakdown voltage of the high-voltage antiferroelectric may be in a range of 9.5 kV/mm to 10.5 kV/mm.

The sintering temperature of the high-voltage antiferroelectric may be in a range of 900° C. to 1100° C.

While the sintering temperature of certain dielectrics may be 1300° C. or higher, the sintering temperature of the dielectric, according to the present disclosure, is relatively low temperature.

In conventional multilayer ceramic capacitors (MLCCs), electrodes may be made of nickel (Ni). However, in the case of the antiferroelectric of the present disclosure, copper (Cu) is used as an electrode for cost reduction. The melting point of Cu is 1085° C., and the Cu electrode can be maintained only when the sintering temperature of the antiferroelectric is lower than 1085° C.

High-Voltage Antiferroelectric Manufacturing Method

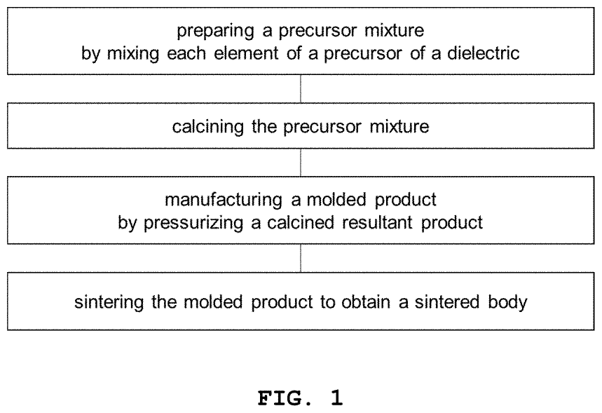

FIG. 1 shows a flowchart showing a method for manufacturing a high-voltage antiferroelectric according to the present disclosure. Hereinafter, the present disclosure is described in more detail with reference to the accompanying drawings.

Referring to FIG. 1, a method for manufacturing a high-voltage antiferroelectric, according to the present disclosure, may include preparing a precursor mixture by mixing each element of a precursor of a dielectric (S10); calcining the precursor mixture (S20); manufacturing a molded product by pressurizing a calcined product (S30); and sintering the molded product to obtain a sintered body (S40).

Act S10 involves preparing a precursor mixture by mixing each element of a precursor of a dielectric. The precursor of the dielectric is mixed and synthesized to provide an element capable of constituting the dielectric framework of the present disclosure and specifically includes elements such as lead, zirconium, titanium, lanthanum, and tin.

The precursor of the dielectric may include 50% to 60% by weight of oxide (PbO), 15% to 30% by weight of zirconium oxide (ZrO₂), 1% to 5% by weight of titanium oxide (TiO₂), 8% to 14% by weight of lanthanum oxide (La₂O₅), and 1% to 16% by weight of tin oxide (SnO₂).

At this time, if the content is out of the above range, it is impossible to obtain an antiferroelectric including lead, zirconium, titanium, lanthanum, and tin in an optimal molar ratio.

Act S20 involves calcining the precursor mixture.

Specifically, it is preparing a molded product with a precursor mixture and performing heat treatment before sintering.

The calcination may be performed at a temperature in a range of 700° C. to 900° C. and for 2 hours to 5 hours.

After the calcination, a pulverizing may be added as necessary to form a powder of even particles.

Act S30 involves manufacturing a molded product by pressurizing a calcined product. The calcined material may be granulated before molding, e.g., mixed with a binder and a solvent to be granulated.

A granulated calcined product may be molded into a desired shape, and may be performed by pressing, for example.

When the binder and the solvent are used, the binder removal and fixation for removing the binder and the solvent may be further performed, and the binder removal process may be performed through heat treatment at a temperature in a range of 500° C. to 700° C., and the binder and the solvent may be removed by the heat treatment.

Act S40 involves obtaining a sintered body by sintering the molded product. Sintering may be performed for the purpose of making the calcined powder particles constituting the molded product adhere to each other and harden.

In the present disclosure, a sintering agent is added in this act, and the sintering agent is added for the purpose of lowering the sintering temperature but also has the effect of increasing the density and shrinkage of the dielectric.

The sintering agent may include 0.01% to 4% by weight of zinc oxide (ZnO) and 0.01% to 10% by weight of lead oxide (PbO).

The sintering agent may include 2% to 4% by weight of zinc oxide (ZnO) and 6% to 10% by weight of lead oxide (PbO), based on the total amount of the antiferroelectric.

At this time, when the ZnO content of the sintering agent is less than 0.01% by weight, a problem in which the density is lowered may occur. In addition, when the PbO content of the sintering agent is less than 10% by weight, a problem in that both the density and the degree of shrinkage are lowered may occur.

The manufacturing of the sintered body may be performed at a temperature in a range of 900° C. to 1100° C. for 2 to 5 hours. While the sintering temperature of certain dielectric manufacturing processes is 1300° C. or higher, the sintering, according to the present disclosure, is performed at a relatively low temperature.

Capacitor

The capacitor of the present disclosure includes the antiferroelectric of the present disclosure and an electrode disposed on the surface of the antiferroelectric.

The electrode includes copper (Cu).

Hereinafter, the present disclosure is described in more detail through specific Experimental Examples. However, the experimental examples of the present disclosure are intended to illustrate the present disclosure, and the scope of the present disclosure is not limited or limited thereby.

### Experimental Example 1: Effect of Adding Sn to PLZT

An experiment was conducted to confirm the effect of substituting Pb with Sn by adding Sn to PLZT.

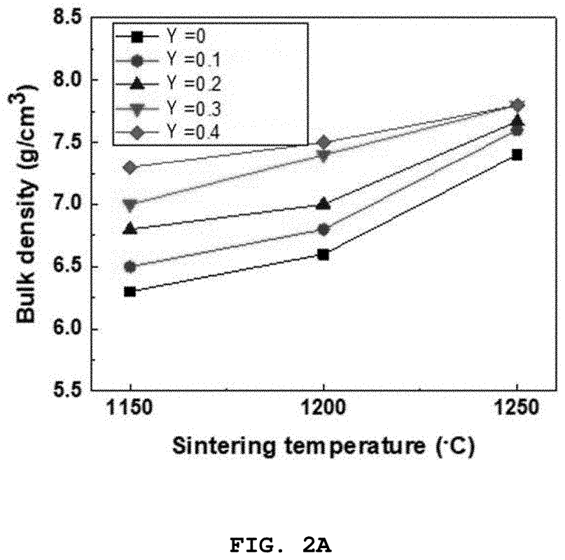

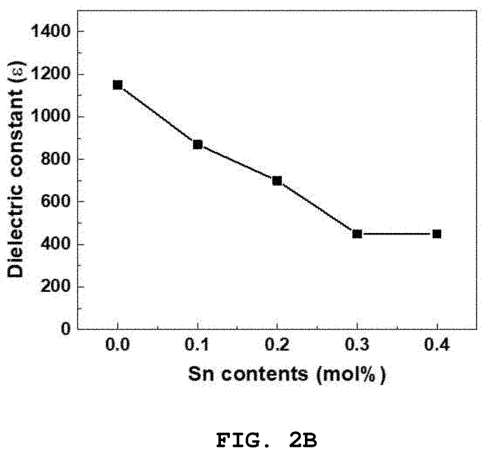

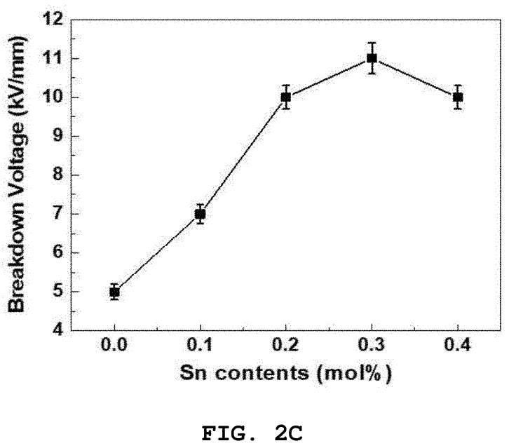

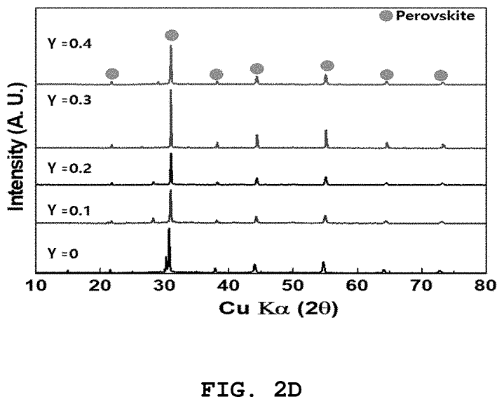

FIG. 2A shows a density according to the sintering temperature according to the Y value in the composition of Pb_{0.88}La_{0.12}([Zr_{1-Y}Sn_{Y}]_{0.86}Ti_{0.14}). FIG. 2B shows a dielectric constant according to the Y value in the composition of Pb_{0.88}La_{0.12}([Zr_{1-Y}Sn_{Y}]_{0.86}Ti_{0.14}). FIG. 2C shows a breakdown voltage according to the Y value in the composition of Pb_{0.88}La_{0.12}([Zr_{1-Y}Sn_{Y}]_{0.86}Ti_{0.14}). FIG. 2D shows the X-ray diffraction (XRD) according to the Y value in the composition of Pb_{0.88}La_{0.12}([Zr_{1-Y}Sn_{Y}]_{0.86}Ti_{0.14}).

Referring to FIGS. 2A to 2C, it can be seen that as the Y (Sn molar ratio) value increases, the dielectric constant decreases, but the density and the breakdown voltage increase. In addition, referring to FIG. 2D, it can be confirmed that the existing perovskite structure is maintained even when Sn is added.

### Experimental Example 2: Low-Temperature Sintering Effect of ZnO

Through Experimental Example 1, it was confirmed that when Y=0.3, the dielectric constant was low, but the density and the breakdown voltage were excellent. Accordingly, in the sintering act, to confirm the low-temperature sintering effect based on Y=0.3, 2% and 2.5% by weight of NiO and 2% and 2.5% by weight of ZnO were added as sintering agents, and the density at a sintering temperature in a range of 950° C. to 1100° C. was measured.

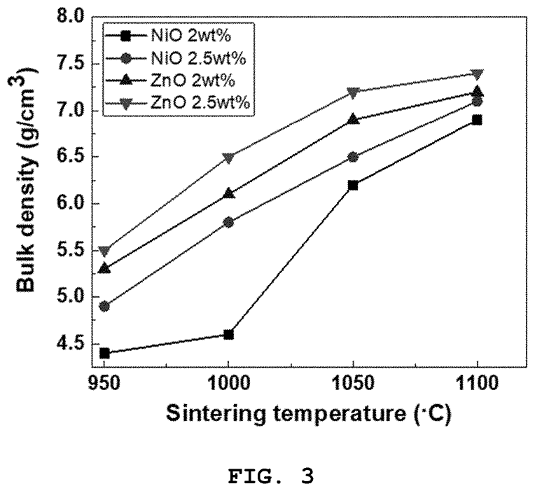

FIG. 3 shows a density according to the sintering temperature when NiO and ZnO are added to the composition of Pb_{0.88}La_{0.12}([Zr_{0.7}Sn_{0.3}]_{0.86}Ti_{0.14}).

Referring to FIG. 3, it can be seen that ZnO has a superior low-temperature sintering effect to NiO.

### Experimental Example 3: Low-Temperature Sintering Effect of ZnO+PbO

Although it was possible to confirm the low-temperature sintering effect of ZnO through Experimental Example 2, it was not achieved at the expected sintering density of 7.6 g/cm³ of the present disclosure. As a result of continuing the experiment, ZnO alone was not effective at 2% by weight or more, so it was decided to additionally add another low-temperature sintering agent. Because PbO is also used as compensation for volatilization in the PLZT composition, the possibility of a secondary phase compared to other additives was low, so PbO was used.

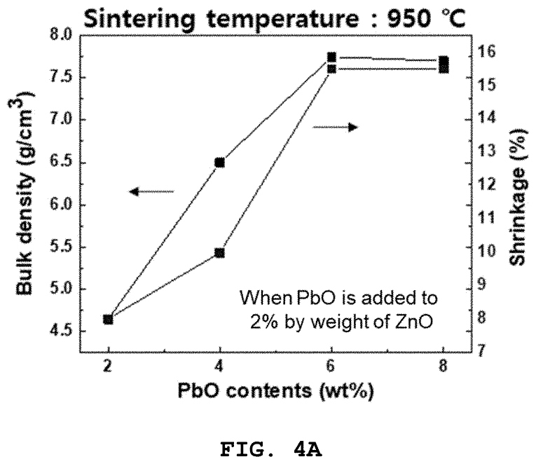

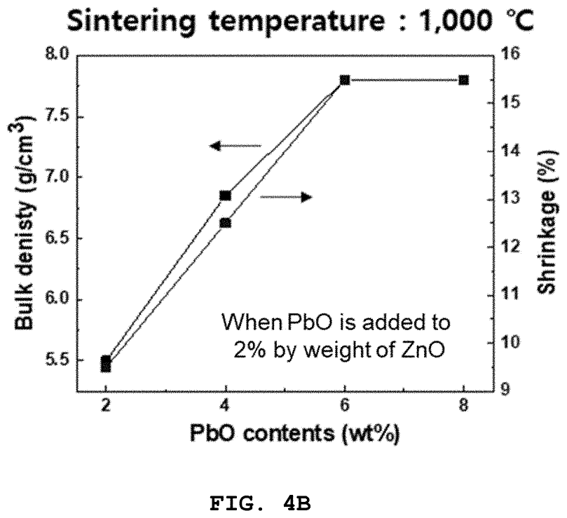

FIG. 4A shows a density and shrinkage according to the PbO content at a sintering temperature of 950° C. FIG. 4B shows a density and shrinkage according to the PbO content at a sintering temperature of 1000° C.

Referring FIGS. 4A and 4B, when PbO is added to 2% by weight of ZnO, it can be confirmed that sintering is possible at less than 1000° C., and the density reaches 7.5 g/cm³. In addition, referring to FIG. 4A, e.g., when 6% to 8% by weight of PbO is added, it can be confirmed that the most effective in both density and shrinkage.

### Experimental Example 4: Effects of Sn Content

Through Experimental Example 1, the effect of substituting Sn for Pb by adding Sn to PLZT was confirmed. Accordingly, an experiment was conducted to derive the molar ratio of Sn capable of obtaining high shrinkage, high density, high dielectric constant, and high breakdown voltage.

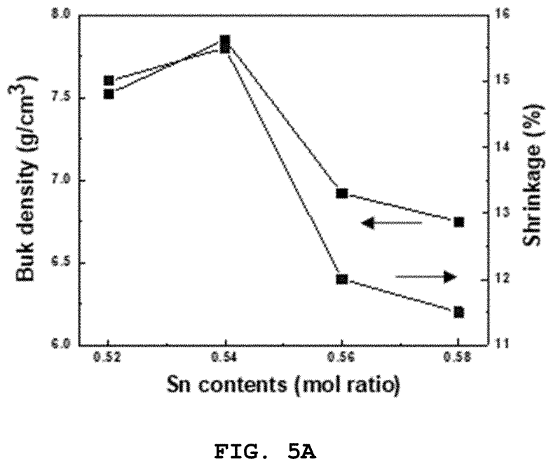

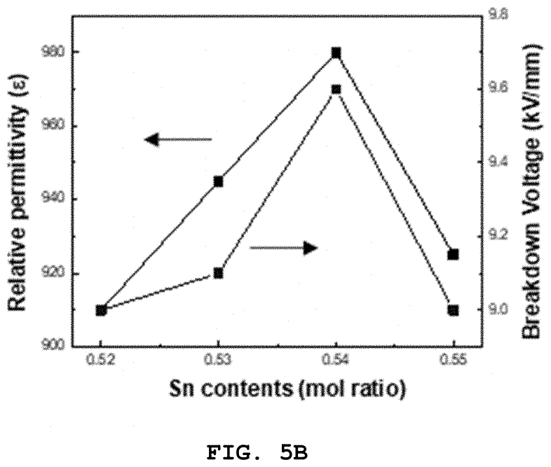

FIG. 5A shows a density and shrinkage according to the Sn molar ratio (Y value) in the composition of Pb_{0.88}La_{0.12}([Zr_{1-Y}Sn_{Y}]_{0.86}Ti_{0.14}). FIG. 5B shows a dielectric constant and breakdown voltage according to the Sn molar ratio (Y value) in the composition of Pb_{0.88}La_{0.12}([Zr_{1-Y}Sn_{Y}]_{0.86}Ti_{0.14}).

Referring FIGS. 5A and 5B, it can be seen that the shrinkage, density, permittivity, and breakdown voltage are the highest when Pb_{0.88}La_{0.12}([Zr_{0.46}Sn_{0.54}]_{0.86}Ti_{0.14}) with Y=0.54.

### Experimental Example 5: Effects of (Zr, Sn) Content

Through Experimental Example 4, it can be confirmed that when Y=0.54, the sintering temperature, density, shrinkage, and breakdown voltage targeted by the present disclosure were achieved. While maintaining Sn at 0.54, an experiment was performed to obtain a higher breakdown voltage than the conventional one through a change in the relative content with Ti, with Zr and Sn as a bundle.

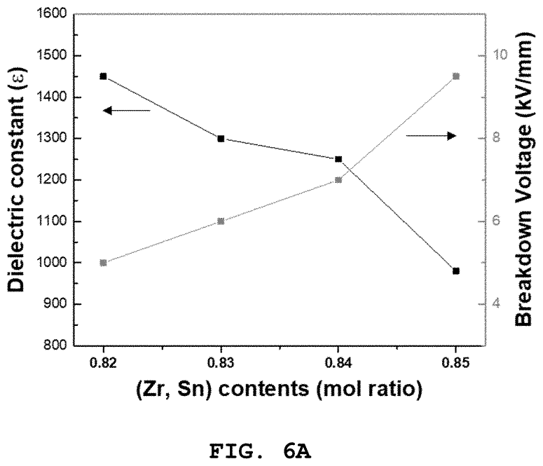

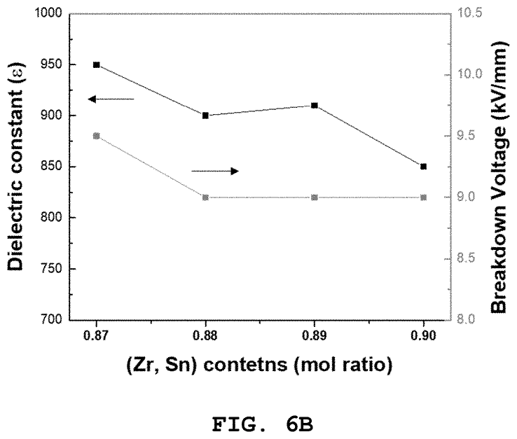

FIG. 6A shows a dielectric constant and breakdown voltage when the Z value is less than 0.84 in the composition of Pb_{0.88}La_{0.12}([Zr_{0.46}Sn_{0.54}]_{Z}Ti_{1-Z}).

FIG. 6B shows a dielectric constant and breakdown voltage when the Z value is greater than 0.88 in the composition of Pb_{0.88}La_{0.12}([Zr_{0.46}Sn_{0.54}]_{Z}Ti_{1-Z}).

Referring FIGS. 6A to 6B, when the composition is Pb_{0.88}La_{0.12}([Zr_{0.46}Sn_{0.54}]_{0.76}Ti_{0.24}) with Z=0.86, a density of 7.8 g/cm³ or more, a dielectric constant of 900 or more, a breakdown voltage of 9.5 kV/mm or more, and a low sintering temperature of 950° C. could be obtained.

Therefore, the high-voltage antiferroelectric, according to the present disclosure, has a PbₓLa₁₋ₓ([Zr_{1-Y}Sn_{Y}]_{Z}Ti_{1-Z}) composition, is sintered at a low temperature through appropriate mixing, and may provide an antiferroelectric having high density and high breakdown voltage.

Although the present disclosure has been described above, it will be understood by those skilled in the art that the present disclosure may be implemented in other specific forms without changing the technical spirit or essential features thereof. Therefore, it should be understood that the embodiments described above are illustrative in all respects and not restrictive.

What is claimed is:

1. An antiferroelectric comprising:
a PbₓLa₁₋ₓ([Zr_{1-Y}Sn_{Y}]_{Z}Ti_{1-Z}) composition,
wherein X is in a range of 0.86 to 0.90,
Y is in a range of 0.52 to 0.56, and
Z is in a range of 0.84 to 0.88.

5. The antiferroelectric of claim 1, wherein a density of the antiferroelectric is in a range of 7.5 g/cm³ to 8.0 g/cm³.

6. The antiferroelectric of claim 1, wherein a permittivity of the antiferroelectric is in a range of 900 to 1000.

7. The antiferroelectric of claim 1, wherein a breakdown voltage of the antiferroelectric is in a range of 9.5 kV/mm to 10.5 kV/mm.

8. The antiferroelectric of claim 1, wherein a sintering temperature of the antiferroelectric is in a range of 900° C. to 1100° C.

9. A method of manufacturing an antiferroelectric, the method comprising:
preparing a precursor mixture by mixing each element of a precursor of a dielectric;
calcining the precursor mixture;
manufacturing a molded product by pressurizing a calcined resultant product; and
sintering the molded product to obtain a sintered body,
wherein the antiferroelectric comprises a PbₓLa₁₋ₓ([Zr_{1-Y}Sn_{Y}]_{Z}Ti_{1-Z}) composition, wherein X is in a range of 0.86 to 0.90, Y is in a range of 0.52 to 0.56, and Z is in a range of 0.84 to 0.88.

10. The method of claim 9, wherein the precursor of the dielectric comprises:
50% to 60% by weight of lead oxide (PbO);
15% to 30% by weight of zirconium oxide (ZrO₂);
1% to 5% by weight of titanium oxide (TiO₂);
8% to 14% by weight of lanthanum oxide (La₂O₅); and
1% to 16% by weight of tin oxide (SnO₂).

11. The method of claim 9, wherein the molded product is sintered with a sintering agent to obtain the sintered body, and
wherein the sintering agent comprises 1% to 4% by weight of zinc oxide (ZnO) and 1% to 10% by weight of lead oxide (PbO), based on a total amount of the antiferroelectric.

15. The method of claim 9, wherein a density of the antiferroelectric is in a range of 7.5 g/cm³ to 8.0 g/cm³.

16. The method of claim 9, wherein a permittivity of the antiferroelectric is in a range of 900 to 1000.

17. The method of claim 9, wherein a breakdown voltage of the antiferroelectric is in a range of 9.5 kV/mm to 10.5 kV/mm.

18. The method of claim 9, wherein a sintering temperature of the antiferroelectric is in a range of 900° C. to 1100° C.

19. A capacitor comprising:
an antiferroelectric; and
an electrode disposed on a surface of the antiferroelectric,
wherein the electrode comprises copper (Cu), and
wherein the antiferroelectric comprises a PbₓLa₁₋ₓ([Zr_{1-Y}Sn_{Y}]_{Z}Ti_{1-Z}) composition, wherein X is in a range of 0.86 to 0.90,
Y is in a range of 0.52 to 0.56, and
Z is in a range of 0.84 to 0.88.
